(19) United States
(12) Patent Application Publication
(10) Pub. No.: US 2023/0301385 A1
(43) Pub. Date: Sep. 28, 2023

(54) T-Shirt Ruler Guide

(71) Applicant: Dusit Chairat, Bangkok (TH)

(72) Inventor: Dusit Chairat, Bangkok (TH)

(21) Appl. No.: 18/188,277

(22) Filed: Mar. 22, 2023

Related U.S. Application Data
(60) Provisional application No. 63/323,956, filed on Mar. 25, 2022.

(51) Int. Cl. A41H 1/00

(52) U.S. Cl. CPC A41H 1/00

(57) ABSTRACT

A t-shirt ruler guide comprises a guide element having a collar notch, frontside and backside markings. The frontside and backside markings comprise a plurality of rulers, and a plurality of guidelines. The guidelines comprise a plurality of shoulder guidelines and breastplate guidelines. The t-shirt guide ruler provides an apparatus for consistently placing graphics on t-shirts. The plurality of guidelines and the collar notch provides consistent placement of the graphics by lining the collar of the t-shirt with the collar notch and the shoulder seams with the shoulder guidelines. This allows the graphic to be placed in the center of the t-shirt or over the left or right breastplate.

The current application claims a priority to the U.S. provisional patent application Ser. No. 63/323,956 filed on Mar. 25, 2022.

### FIELD OF THE INVENTION

The present invention relates generally to measuring equipment. More specifically, a measuring equipment used to help a user align the graphic design placement on a T-shirt.

### BACKGROUND OF THE INVENTION

When making t-shirts, there is a need to place graphics on the t-shirt to be more appealable to consumers. The graphic could be any design, word, or phrase. Many companies have machines that print graphics on t-shirts. For smaller graphic design shops, this is not possible as the machines are expensive. The graphic designer must place the graphic in the correct and most appealable location on the t-shirt and this must be done consistently for many t-shirts over multiple days and weeks.

An objective of the present invention is to provide a guide for the placement of t-shirt graphics in the desired location.

A further objective of the present invention is to provide a guide to align graphics in a consistent manner over a plethora of t-shirts.

A further objective of the present invention is to provide a guide to align graphics on both light and dark fabrics.

### SUMMARY OF THE INVENTION

The t-shirt ruler guide is to help a user align the graphic design placement on a t-shirt. The t-shirt ruler guide comprises a collar notch, and double-printed markings on a front and back side. The markings comprise a plurality of rulers and guidelines for facilitating the placement of the graphics on the t-shirt. The user can place the t-shirt ruler guide on a t-shirt before placing the graphic design on t-shirt. The ruler is made of clear acrylic with the dimensions of 17-inch by 7 inches. The lines can be red and black on the front side. The lines are white on the back side. This was made by 2-layer color coating. The first layer is black and/or red, and the second layer is white. The ruler is designed to use on both sides of the ruler. The different color guidelines on the front and back side is so the user can apply this guide ruler on both light and dark fabrics. The letters and numbers on the left side of ruler are reversed. This is for a user to be able to read the letters and numbers when a user uses the flipped side. The guidelines and gridlines are especially designed with 1 inch gap and a special angle that match with shoulder line on T-shirt.

### BRIEF DESCRIPTION OF THE DRAWINGS

FIG. 1 is a front view of the present invention.

FIG. 2 is a rear view of the present invention.

FIG. 3A is a partial view of the frontside of the present invention.

FIG. 3B is a partial view of the backside of the present invention.

FIG. 4A is a top side view of the present invention.

FIG. 4B is a right-side view of the present invention.

### DETAIL DESCRIPTIONS OF THE INVENTION

All illustrations of the drawings are for the purpose of describing selected versions of the present invention and are not intended to limit the scope of the present invention.

The specification includes references to “alternative embodiment” or “alternative embodiments” which do not necessarily refer to the same embodiment.

“First”, “second” etc. as contained herein are terms used as labels for nouns that they precede and do not imply ordering.

The terms “t-shirt” or “t-shirts” are defined herein as any collared shirt that can receive graphics for design purposes.

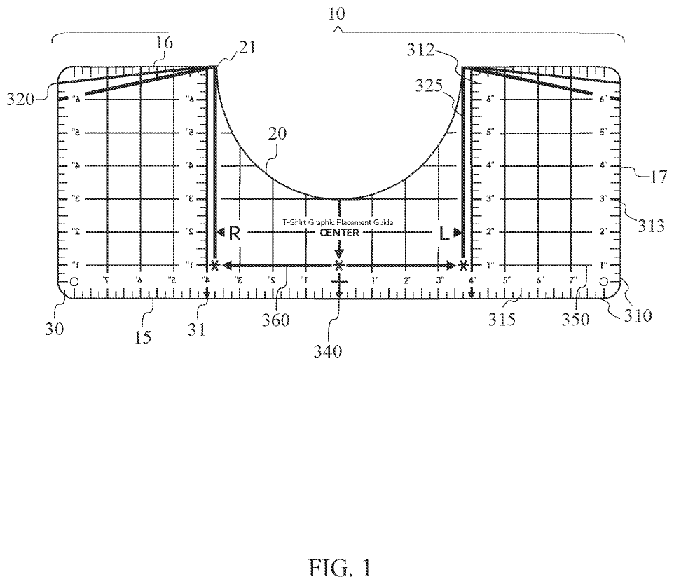

Referring to FIG. 1, a t-shirt guide ruler 10 comprises a frontside 30, a plurality of straight edges 15, a collar notch 20, and frontside markings 31. In the first preferred embodiment, the plurality of straight edges 15 comprises at least one horizontal straight edge 16, and at least one vertical straight edge 17 with the horizontal straight edge 16 generally perpendicular to the vertical straight edge 17. The collar notch 20 comprises a semi-circular notch with a radially inner edge. The collar notch 20 is positioned generally central along the horizontal straight edge 16 but is not limited to this position along the horizontal straight edge 16 and forming a set of junctions 21 between the collar notch 20 and the horizontal straight edge 16. The semi-circular notch having a notch diameter consistent with an adult sized t-shirt collar diameter generally about 8 inches but not limited to this. The collar notch 20 is to align the present invention with the collar of a t-shirt. The frontside markings 31 comprise a plurality of frontside rulers 310, a frontside centerline 340, a plurality of frontside shoulder guidelines 320, a plurality of frontside breastplate guidelines 325.

The frontside centerline 340 bifurcates the frontside 30 into equal sized left and right halves. The plurality of frontside rulers 310 comprises at least one horizontal frontside edge ruler 315 and at least one vertical frontside edge ruler 313. The horizontal frontside edge ruler 315 is marked along the entire length of the horizontal straight edge 16 which divides the horizontal straight edge 16 on the frontside into equal increments and with a horizontal subset of an equidistant increment having numbering for facilitating measuring. The vertical frontside edge ruler 313 is marked along the entire length of the vertical straight edge 17 which divides the vertical straight edge 17 on the frontside into equal increments and with a vertical subset of a vertical equidistant increment having numbering for facilitating measuring. Numbering is reversed for the horizontal 16 and the vertical 17 frontside edge rulers in one of the halves defined by the frontside centerline 340. The plurality of frontside rulers 310 further comprises at least one vertical frontside inner ruler 312. The vertical frontside inner ruler 312 divide the vertical length of the present invention into equal increments and are coincident with the frontside vertical edge rulers 313. The frontside markings 31 further comprises a plurality of frontside matrix guidelines 350. The plurality of frontside matrix guidelines 350 comprises of vertical and horizontal matrix guidelines equidistant to each other and are visible in unused area on the frontside 30. The plurality of frontside rulers 310 and matrix guidelines 350 is to facilitate in the placement of a t-shirt graphic in a consistent location.

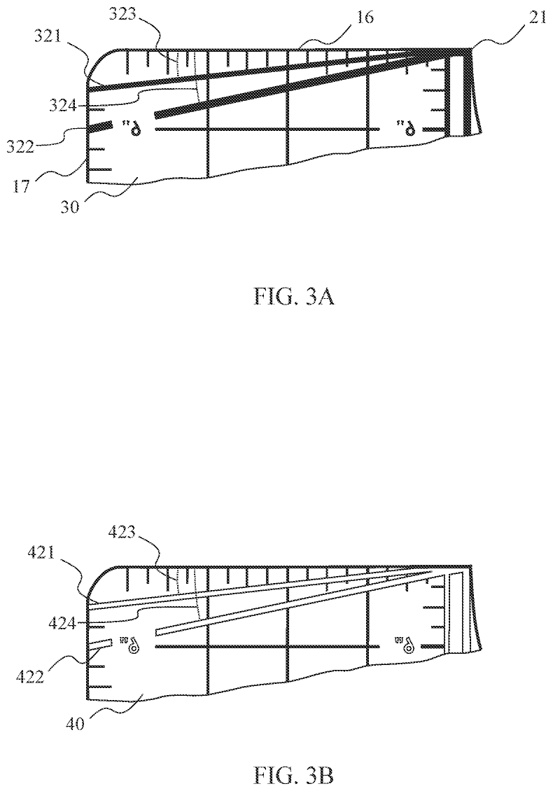

As shown in FIG. 3A, the plurality of frontside shoulder guidelines 320 comprises a first set of frontside shoulder guidelines 321 and a second set of frontside shoulder guidelines 322. The first set of frontside shoulder guidelines 321 and the horizontal straight edge 16 define a first angle theta 323 with the apex of each frontside shoulder guideline being coincident with either of the junctions 21 between the collar notch 20 and the horizontal straight edge 16 but not limited to this position. The second set of frontside shoulder guidelines 322 and the horizontal straight edge 16 define a second angle theta 324 with the apex of the second set of frontside shoulder guidelines 322 being coincident with the first apex of the first set of frontside shoulder guidelines 321. In the first preferred embodiment, first theta 323 is between 5 to 10 degrees and second theta 324 is between 15 to 20 degrees. The plurality of frontside breastplate guidelines 325 are vertical breastplate guidelines that are to facilitate in the consistent placement of the t-shirt graphic over left or right breastplate of the t-shirt. In the first preferred embodiment, the plurality of frontside breastplate guidelines 325 includes a left and a right frontside breastplate guideline. The left and right frontside breastplate guidelines are placed with a top end of each the frontside breastplate guideline being coincident with the apex of either symmetrical side of the plurality of frontside shoulder guidelines 320 but are not limited to this.

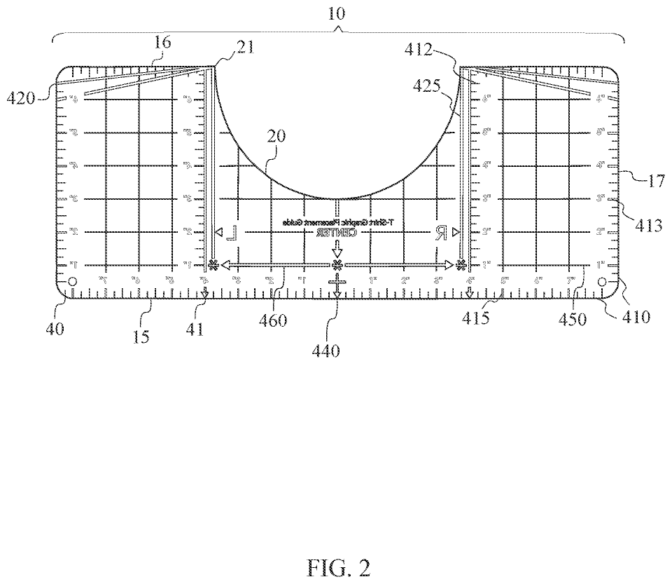

As shown in FIG. 2, the present invention further comprises a backside 40 and backside markings 41. The backside markings 41 comprise a plurality of backside rulers 410, a backside centerline 440, a plurality of backside shoulder guidelines 420, and a plurality of backside breastplate guidelines 425. The backside centerline 440 bifurcates the backside 40 into equal sized left and right backside halves. The plurality of backside rulers 410 comprises at least one horizontal backside edge ruler 415 and at least one vertical backside edge ruler 413. The horizontal backside edge ruler is marked along the entire length of the horizontal straight edge 16 which divides the horizontal straight edge 16 on the backside 40 into equal increments and with a backside horizontal subset of an equidistant increment having numbering for facilitating measuring. The vertical backside edge ruler 413 is marked along the entire length of the vertical straight edge 17 which divides the vertical straight edge 17 on the backside 40 into equal increments and with a vertical subset of a vertical equidistant increment having numbering for facilitating measuring. Numbering is reversed for the horizontal 415 and the vertical 413 backside edge rulers in one of the backside halves defined by the backside centerline 440. The plurality of backside rulers 410 further comprises at least one vertical backside inner ruler 412. The vertical backside inner ruler 412 divides the vertical length of the present invention into equal increments and are coincident with the backside vertical edge rulers 413. The backside markings 41 further comprises a plurality of backside matrix guidelines 450. The plurality of backside matrix guidelines 450 comprises vertical and horizontal matrix guidelines equidistant to each other and are visible in unused area on the backside 40. The plurality of backside rulers 410 and matrix guidelines 450 is to facilitate in the placement of a t-shirt graphic in a consistent location. In the first preferred embodiment, the backside markings 41 are coincident with the frontside markings 31 and the backside markings 41 are lighter in color relative to the frontside markings 31. The backside marking 40 are also lighter in color to the frontside markings 30. This is to help in seeing the markings with different colors of t-shirt fabric where the frontside 30 can be used with lighter colors relative to the frontside markings 31 and the backside 40 can be used for darker colors relative to the backside markings 41.

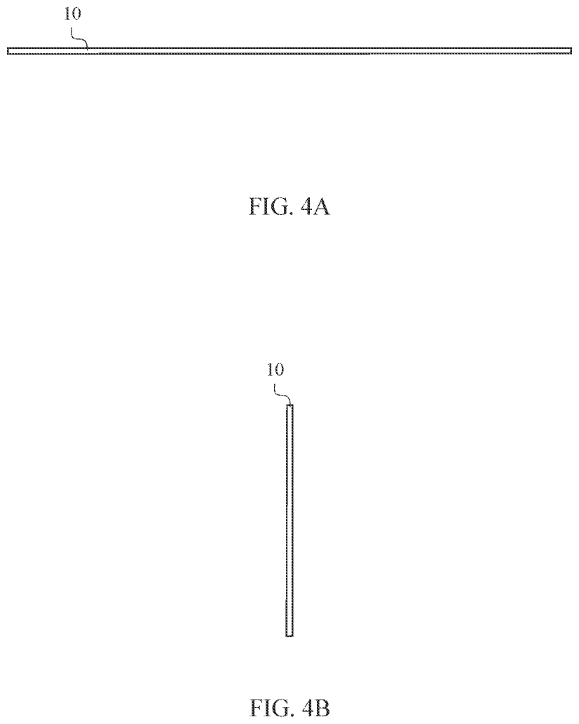

As shown in FIG. 3B, the plurality of backside shoulder guidelines 420 comprises a first set of backside shoulder guidelines 421 and a second set of backside shoulder guidelines 420. The first set of backside shoulder guidelines 420 and the horizontal straight edge 16 define a first backside theta 423 with a first backside apex of the backside shoulder guidelines 420 being coincident with either of the junctions 21 between the collar notch 20 and the horizontal straight edge 16. The second set of backside shoulder guidelines 422 and the horizontal straight edge 16 define a second backside theta 424 with a second backside apex of the backside shoulder guidelines being coincident with either of the junctions 21 between the collar notch 20 and the horizontal straight edge 16. In the first preferred embodiment, the first backside theta 423 is between to 10 degrees and second backside theta 424 is between 15 to 20 degrees. The shoulder guidelines are to facilitate in aligning the present invention with at least one t-shirt shoulder seam. The backside centerline 440 bifurcates the backside 40 into equal sized left and right backside halves. The plurality of backside breastplate guidelines 425 are vertical breastplate guidelines that are to facilitate in the consistent placement of the t-shirt graphic over left or right breastplate of the t-shirt. In the first preferred embodiment, the plurality of backside breastplate guidelines 425 includes a left and a right backside breastplate guideline. The left and right backside breastplate guidelines are placed with a top end of each the backside breastplate guideline being coincident with the apex of either symmetrical side of the plurality of backside shoulder guidelines 420 but are not limited to this. FIG. 4A and FIG. 4B show the top view and a right-side view of the present invention.

The operation of the present invention is performed by placing the present invention on a t-shirt for placement of the graphic with either the frontside 30 on top or the backside 40 on top depending on the t-shirt fabric color as discussed above. The collar notch 20 radially inner edge is aligned with an outer edge of the collar of the t-shirt. The shoulder seams are aligned with the appropriate set of either frontside 320 or backside 420 shoulder guidelines. The user aligns the graphic to the predetermined location of the t-shirt graphic whether the location is in the center of the t-shirt, or over the left or right breastplate 325. The graphic can either reference the centerline or either breastplate guideline or use the plurality of rulers for consistent placement of the t-shirt graphic.

In the first preferred embodiment, the present invention is made of clear acrylic with the dimensions of 17-inch by 7 inches. Some of the lines can be red and black on the front side. The lines are white on the back side. This was made by 2-layer color coating. The first layer is black and/or red, and the second layer is white. The ruler is designed to use on both sides of the ruler. The black or red guidelines and gridlines are on front side and the white guidelines and gridlines are on back side. This is for a user to apply this ruler on both light and dark fabrics. The letters and numbers on the left side of ruler are reversed. This is for a user to be able to read the letters and numbers when a user uses the flipped side. The guideline and gridline are especially designed with 1 inch gap and a special angle that match with shoulder line on T-shirt.

Although the invention has been explained in relation to its preferred embodiment, it is to be understood that many other possible modifications and variations can be made without departing from the spirit and scope of the invention.

1. A t-shirt guide ruler comprises:
a frontside;
a backside;
a plurality of straight edges;
a collar notch;
frontside markings; and
the frontside markings comprising:
a plurality of frontside rulers,
a frontside centerline,
a plurality of frontside shoulder guidelines, and
a plurality of frontside breastplate guidelines.

2. The t-shirt guide ruler as claimed in claim 1, further comprising:
the plurality of straight edges further comprising at least one horizontal straight edge, and
at least one vertical straight edge
the plurality of frontside shoulder guidelines further comprising a first set of frontside shoulder guidelines; and
the first set of frontside shoulder guidelines and the horizontal straight edge define a first theta.

3. The t-shirt guide ruler as claimed in claim 2, wherein the first theta is between 5 to 10 degrees.

4. The t-shirt guide ruler as claimed in claim 2, further comprising
the plurality of frontside shoulder guidelines further comprising a second set of frontside shoulder guidelines; and
the second set of frontside shoulder guidelines and the horizontal straight edge define a second theta.

5. The t-shirt guide ruler as claimed in claim 4, wherein the second theta is between 15 to 20 degrees.

6. The t-shirt guide ruler as claimed in claim 1, wherein the plurality of frontside rulers further comprise at least one horizontal frontside edge ruler and at least one vertical frontside edge ruler.

7. The t-shirt guide ruler as claimed in claim 6, wherein the plurality of frontside rulers further comprise at least one vertical frontside inner ruler.

8. The t-shirt guide ruler as claimed in claim 1, wherein one of the halves defined by the frontside centerline include numbering reversed.

9. The t-shirt guide ruler as claimed in claim 1, further comprising a plurality of frontside matrix guidelines.

10. The t-shirt guide ruler as claimed in claim 1, further comprising:
backside markings; the backside markings comprising:
a plurality of backside rulers;
a backside centerline;
a plurality of backside shoulder guidelines; and
a plurality of backside breastplate guidelines.

11. The t-shirt guide ruler as claimed in claim 10, further comprising:
the plurality of straight edges further comprising at least one horizontal straight edge and at least one vertical straight edge;
the plurality of backside shoulder guidelines further comprising a first set of backside shoulder guidelines; and
the first set of backside shoulder guidelines and the horizontal straight edge define a first backside theta.

12. The t-shirt guide ruler as claimed in claim 11, wherein the first backside theta is between 5 to 10 degrees.

13. The t-shirt guide ruler as claimed in claim 11, further comprising:
the plurality of backside shoulder guidelines comprising a second set of backside shoulder guidelines; and
the second set of backside shoulder guidelines and the horizontal straight edge defining a second backside theta.

14. The t-shirt guide ruler as claimed in claim 13, wherein the second backside theta is between 15 to 20 degrees.

15. The t-shirt guide ruler as claimed in claim 10, wherein the plurality of backside rulers comprise at least one horizontal backside edge ruler and at least one vertical backside edge ruler.

16. The t-shirt guide ruler as claimed in claim 15, wherein the plurality of backside rulers comprise at least one vertical backside inner ruler.

17. The t-shirt guide ruler as claimed in claim 10, wherein one of the backside halves defined by the backside centerline include numbering reversed.

18. The t-shirt guide ruler as claimed in claim 10, further comprising:
a plurality of backside matrix guidelines.
